(19) United States
(12) Patent Application Publication
(10) Pub. No.: US 2025/0239801 A1
(43) Pub. Date: Jul. 24, 2025

(54) CONNECTOR AND CONNECTOR DEVICE

(71) Applicant: SUMITOMO WIRING SYSTEMS, LTD., Mie (JP)

(72) Inventor: Taiga KADOYAMA, Mie (JP)

(21) Appl. No.: 19/021,798

(22) Filed: Jan. 15, 2025

(30) Foreign Application Priority Data
Jan. 18, 2024 (JP) 2024-005915

(51) Int. Cl. H01R 13/436; H01R 13/506

(52) U.S. Cl. CPC H01R 13/4365; H01R 13/506

(57) ABSTRACT

A connector of the present disclosure includes a plurality of types of terminals disposed side by side in a first direction, a housing including a plurality of cavities for respectively accommodating the plurality of types of terminals, the terminals being inserted into the cavities from behind in a second direction intersecting the first direction, and a retainer to be mounted on the housing from front in the second direction. An inner wall of the cavity is formed with a pair of locking lances disposed side by side in the first direction. The plurality of types of terminals include at least one elliptical terminal having an elliptical shape in a front view. The elliptical terminal includes a tube portion open forward and long in the first direction and a pair of locked portions for holding the elliptical terminal by being respectively locked by the pair of locking lances.

### CROSS-REFERENCE TO RELATED APPLICATIONS

This application is based on and claims priority from Japanese Patent Application No. 2024-005915, filed on Jan. 18, 2024, with the Japan Patent Office, the disclosure of which is incorporated herein in its entirety by reference.

### TECHNICAL FIELD

The present disclosure relates to a connector and a connector device.

### BACKGROUND

A connector described in Japanese Patent Laid-open Publication No. 2001-110500 is known as a connector in which the rattling of a terminal fitting in a cavity is suppressed. This connector is provided with a female terminal fitting, a connector housing including a cavity for accommodating the female terminal fitting and a retainer to be mounted on the front end of the connector housing. The connector housing includes a locking lance for locking the terminal fitting from behind. The retainer includes a pressing contact portion for pressing the terminal fitting against the ceiling wall of the cavity by contacting the lower surface of the terminal fitting. If the terminal fitting is inserted into the cavity, the terminal fitting is primarily locked by the locking lance. If the retainer is mounted on the connector housing, a restricting piece provided on the retainer enters a deflection space for the locking lance and the deflection and deformation of the locking lance are restricted, whereby the terminal fitting is doubly locked in a retained state. In this state, since the terminal fitting is pressed against the ceiling wall of the cavity by the pressing contact portion, the rattling of the terminal fitting in a vertical direction is suppressed.

### SUMMARY

However, the connector housing and the retainer are separate components and tolerance for assembling these is necessary. Thus, rattling corresponding to this tolerance is allowed. Therefore, even if the retainer is provided with the pressing contact portion, it is difficult to suppress the rattling of the terminal fitting in the vertical direction.

The present disclosure is directed to a connector with a plurality of types of terminals disposed side by side in a first direction, a housing including a plurality of cavities for respectively accommodating the plurality of types of terminals, the terminals being inserted into the cavities from behind in a second direction intersecting the first direction, and a retainer to be mounted on the housing from front in the second direction, an inner wall of the cavity being formed with a pair of locking lances disposed side by side in the first direction, the plurality of types of terminals including at least one elliptical terminal having an elliptical shape in a front view, the elliptical terminal including a tube portion open forward and long in the first direction and a pair of locked portions for holding the elliptical terminal by being respectively locked by the pair of locking lances, the pair of locking lances being deflectable in the first direction, and the retainer including a pair of deflection suppressing portions for respectively suppressing deflection of the pair of locking lances by respectively entering deflection spaces for the pair of locking lances and a pair of supporting walls for supporting an outer peripheral surface of the tube portion from both sides in the first direction.

According to the present disclosure, the rattling of a terminal in a cavity can be suppressed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a male connector of an embodiment when viewed obliquely from front.

FIG. 2 is a front view of the male connector.

FIG. 3 is a perspective view of the male connector when viewed obliquely from behind.

FIG. 4 is an exploded perspective view of the male connector.

FIG. 5 is a perspective view of an elliptical terminal when viewed obliquely from front.

FIG. 6 is a front view of the elliptical terminal.

FIG. 7 is a perspective view of a male housing when viewed obliquely from front.

FIG. 8 is a perspective view of a male retainer when viewed obliquely from behind.

FIG. 9 is a section showing a state where arcuate surfaces of the elliptical terminal are supported by curved surfaces.

FIG. 10 is a section along A-A of FIG. 2 showing a state where the retainer is at a temporary locking position.

FIG. 11 is a section along A-A of FIG. 2 showing a state where the retainer is at a complete locking position.

FIG. 12 is a section along A-A of FIG. 2 showing a state where the male connector and a female connector are properly connected.

FIG. 13 is an enlarged section enlargedly showing a part of FIG. 12.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

The connector of the present disclosure is provided with a plurality of types of terminals disposed side by side in a first direction, a housing including a plurality of cavities for respectively accommodating the plurality of types of terminals, the terminals being inserted into the cavities from behind in a second direction intersecting the first direction, and a retainer to be mounted on the housing from front in the second direction, an inner wall of the cavity being formed with a pair of locking lances disposed side by side in the first direction, the plurality of types of terminals including at least one elliptical terminal having an elliptical shape in a front view, the elliptical terminal including a tube portion open forward and long in the first direction and a pair of locked portions for holding the elliptical terminal by being respectively locked by the pair of locking lances, the pair of locking lances being deflectable in the first direction, and the retainer including a pair of deflection suppressing portions for respectively suppressing deflection of the pair of locking lances by respectively entering deflection spaces for the pair of locking lances and a pair of supporting walls for supporting an outer peripheral surface of the tube portion from both sides in the first direction.

According to this configuration, the pair of supporting walls support the tube portion of the elliptical terminal from the both sides in the first direction, whereby the elliptical terminal is prevented from moving in the first direction. Since the retainer is provided with the pair of supporting walls, the rattling of the elliptical terminal in the cavity can be suppressed by providing the pair of supporting walls in accordance with a dimension in the first direction of the elliptical terminal regardless of tolerance for assembling the retainer with the housing.

[2] Preferably, in [1] described above, the elliptical terminal includes a terminal portion accommodated in the tube portion and long in the second direction, a front end of the terminal portion is located between a front end of the tube portion and a back wall of the tube portion in the second direction, and the pair of supporting walls support a part in front of the back wall, out of the outer peripheral surface of the tube portion.

The part in front of the back wall, out of the outer peripheral surface of the tube portion, is supported by the pair of supporting walls, whereby the rattling of the elliptical terminal in the cavity is easily suppressed.

[3] Preferably, in [1] or [2] described above, the tube portion has a pair of arcuate surfaces located on both end parts in the first direction, the supporting walls have curved surfaces formed along the arcuate surfaces, and the curved surfaces support the tube portion from the both sides in the first direction while contacting the arcuate surfaces.

By doing so, the tube portion of the elliptical terminal can be supported from the both sides in the first direction with the curved surfaces of the respective supporting walls held in contact with the arcuate surfaces of the tube portion.

[4] Preferably, in any one of [1] to [3] described above, the retainer is movable between a temporary locking position for allowing the deflection of the pair of locking lances and a complete locking position for suppressing the deflection of the pair of locking lances, and front ends of the pair of supporting walls are located in front of the front end of the tube portion at the temporary locking position.

Since the front ends of the pair of supporting walls are located in front of the front end of the tube portion, the tube portion is easily protected from the both sides in the first direction at the temporary locking position.

[5]A connector device of the present disclosure is provided with the connector of any one of [1] to [4] described above, a mating housing connectable to the housing, and a mating retainer to be mounted on the mating housing, the mating retainer including a pair of mating supporting walls for supporting the outer peripheral surface of the tube portion from the both sides in the first direction together with the pair of supporting walls when the housing and the mating housing are connected.

According to this configuration, both the pair of supporting walls and the pair of mating supporting walls support the tube portion of the elliptical terminal from the both sides in the first direction, whereby the elliptical terminal is prevented from moving in the first direction.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different in each drawing. Further, “orthogonal” in this specification means not only strictly orthogonal, but also substantially orthogonal within a range in which functions and effects in this embodiment are achieved.

Further, “facing each other” in this specification indicates that surfaces or members are at positions in front of each other, and means not only a case where the surfaces or members are at positions perfectly in front of each other, but also a case where the surfaces or members are partially in front of each other. Further, “facing each other” in this specification means both a case where another member different from two parts is interposed between the two parts and a case where nothing is interposed between the two parts.

### Embodiment

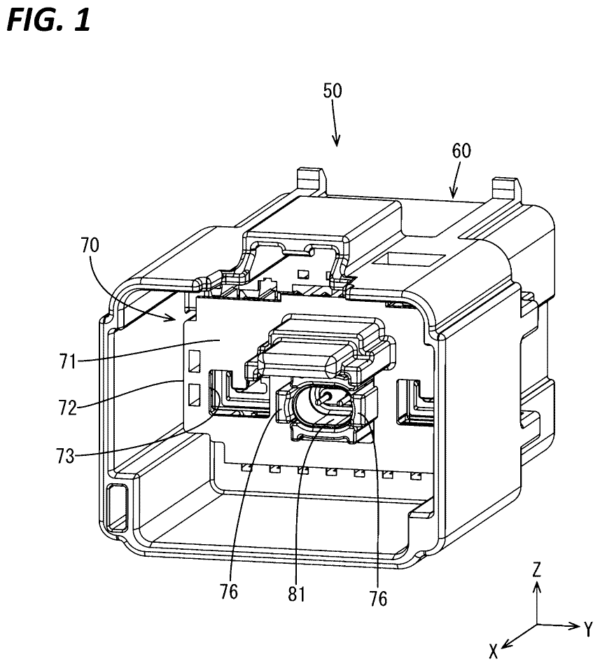

The embodiment of the present disclosure is described with reference to FIGS. 1 to 13. In the following description, a direction indicated by an arrow Z is referred to as an upward direction, a direction indicated by an arrow X is referred to as a forward direction and a direction indicated by an arrow Y is referred to as a leftward direction. A lateral direction is an example of a first direction. A front-rear direction is an example of a second direction. A vertical direction is an example of a third direction. Note that, for a plurality of identical members, only some members may be denoted by a reference sign and the other members may not be denoted by the reference sign.

### (Connector Device 100)

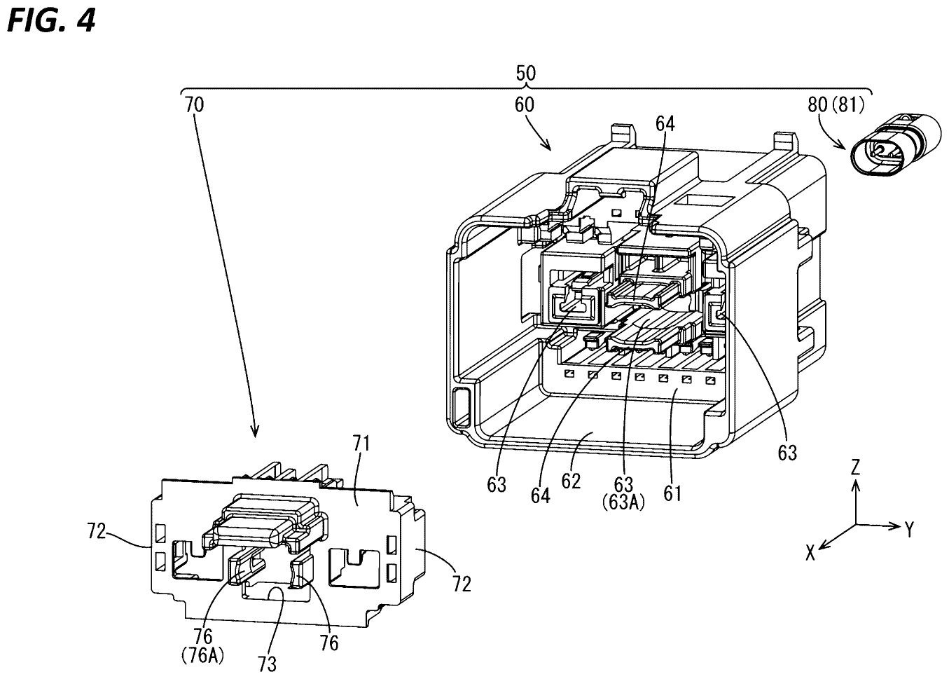

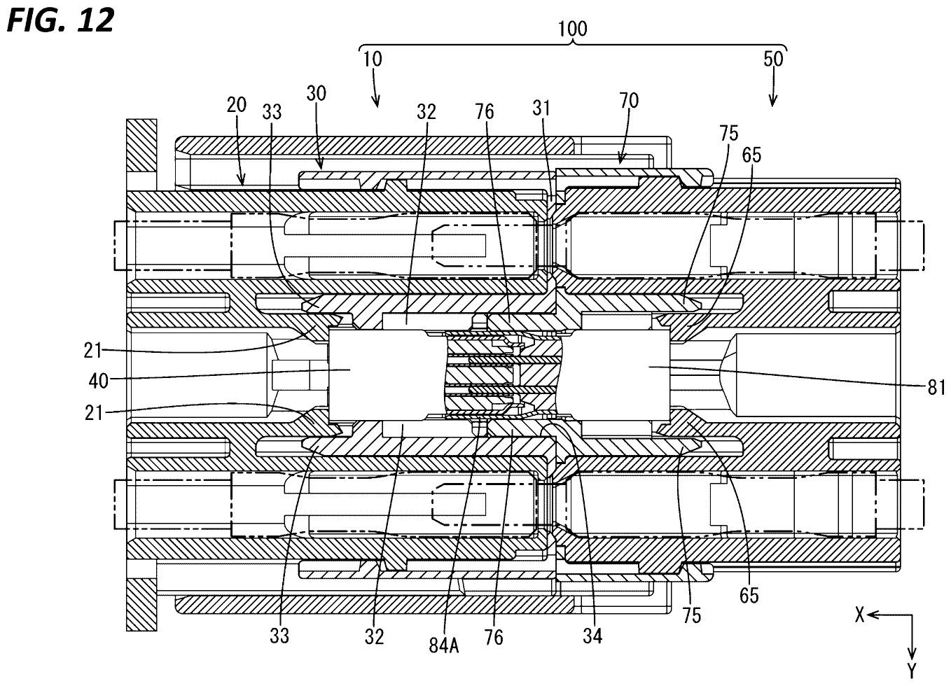

As shown in FIG. 12, a connector device 100 is provided with a male connector 50 and a female connector 10. The female connector 10 is provided with a female housing 20 made of synthetic resin, a female retainer 30 made of synthetic resin and a plurality of types of female terminals 40. As shown in FIGS. 1 and 4, the male connector 50 is provided with a male housing 60 made of synthetic resin, a male retainer 70 made of synthetic resin and a plurality of types of male terminals 80. The female housing 20 corresponds to a “mating housing” of the present disclosure, and the female retainer 30 corresponds to a “mating retainer” of the present disclosure.

### (Male Terminals 80)

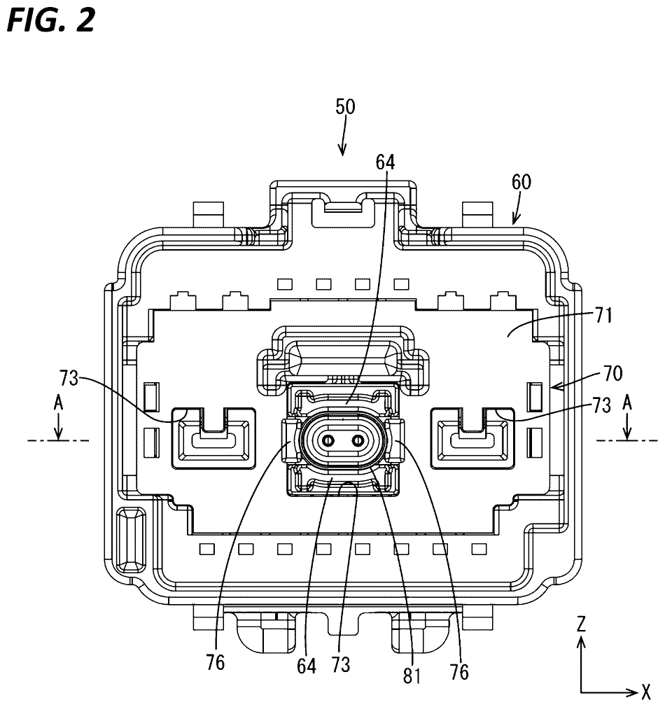

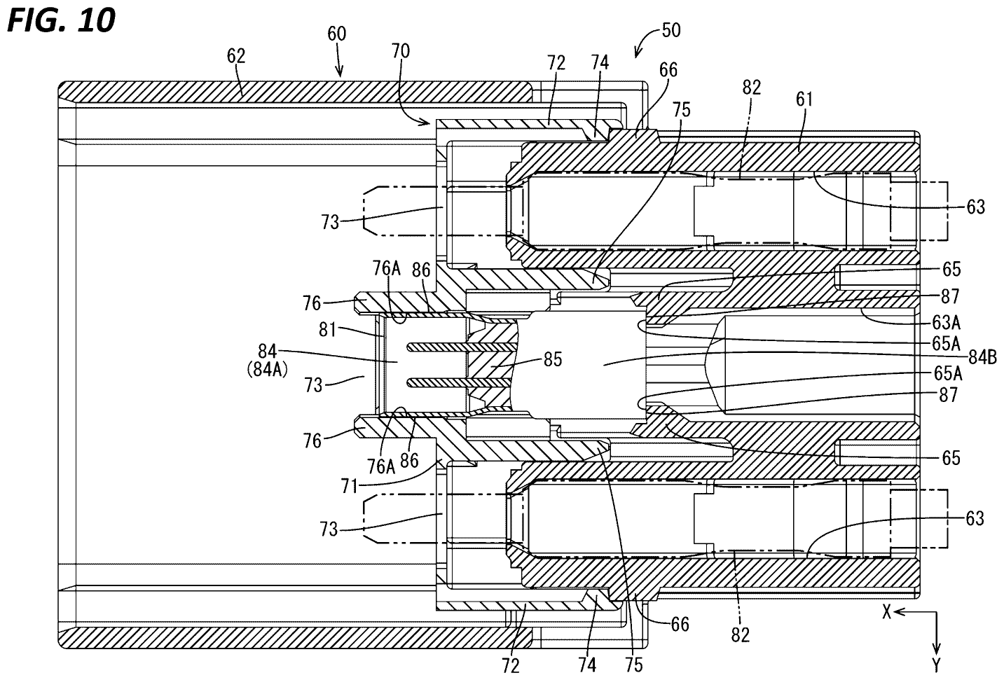

As shown in FIGS. 2 and 10, the plurality of types of male terminals 80 include one elliptical terminal 81 having an elliptical shape in a front view and a pair of tab terminals 82 located on both left and right sides of this elliptical terminal 81. The elliptical terminal 81 and the pair of tab terminals 82 are disposed side by side in the lateral direction. The male terminal 80 is formed by press-working a metal plate excellent in electrical conductivity. Since the male connector 50 is provided with the plurality of types of male terminals 80 (81, 82), the male connector 50 may be called a hybrid connector.

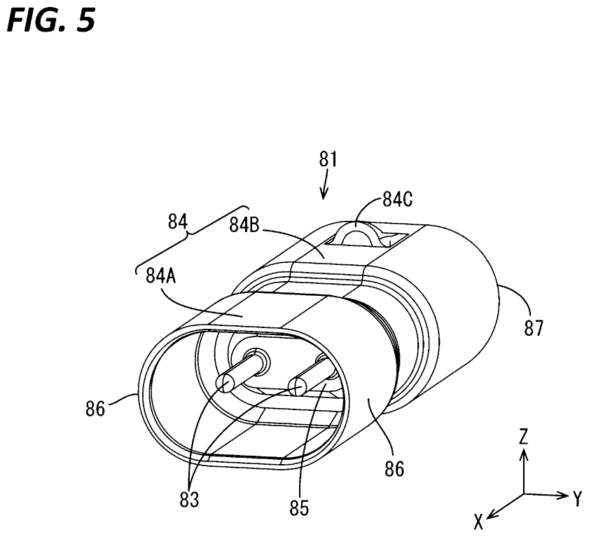

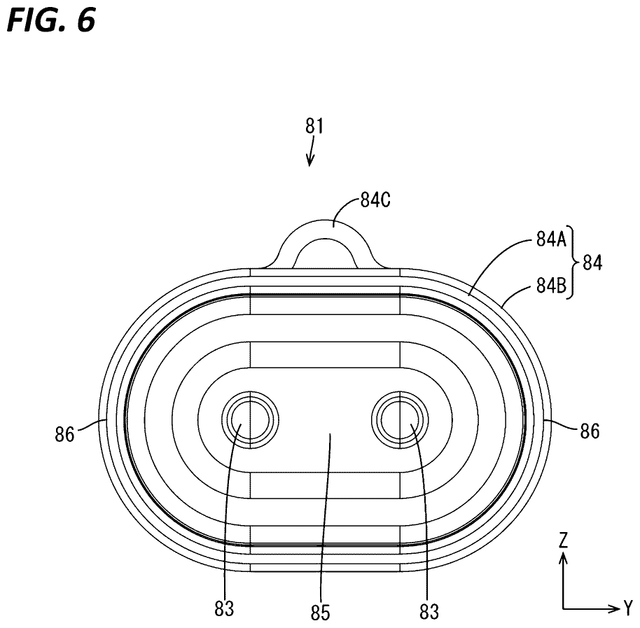

As shown in FIGS. 5 and 6, the elliptical terminal 81 is provided with a pair of pin terminals 83, an electrically conductive shield member 84 surrounding the pair of pin terminals 83 and an insulating member 85 for insulating between the pair of pin terminals 83 and the shield member 84. The pin terminal 83 corresponds to a “terminal portion” of the present disclosure.

The pair of pin terminals 83 are connected to ends of a pair of cables for transmitting differential signals. Since the elliptical terminal 81 is used for a high-speed twisted pair cable, the male connector 10 may be called an HMTD (High-Speed Modular Twisted Piar Data) connector.

The shield member 84 includes a front tube portion 84A open forward and long in the lateral direction when viewed from front, a rear tube portion 84B disposed behind the front tube portion 84A and a front stop protrusion 84C projecting upward from the upper surface of the rear tube portion 84B. The front tube portion 84A includes a pair of arcuate surfaces 86 formed on both end parts in the lateral direction, and the rear tube portion 84B includes a pair of locked portions 87 formed on a rear end part. The front stop protrusion 84C is a protrusion for stopping the elliptical terminal 81 in front in the male housing 60. The pair of locked portions 87 are disposed side by side in the lateral direction.

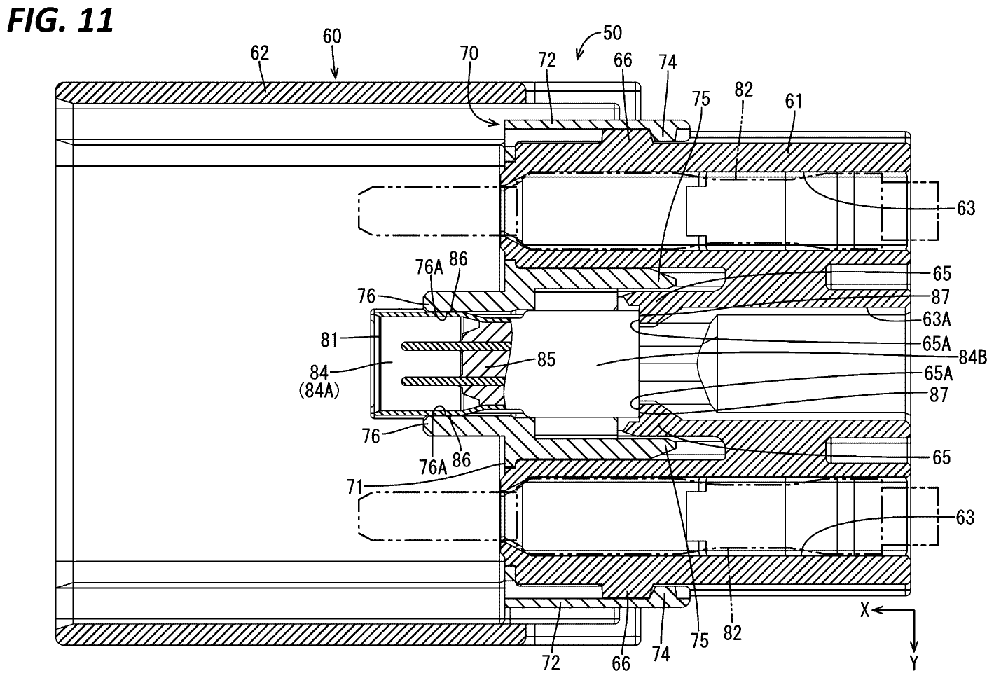

As shown in FIGS. 10 and 11, the front end of the insulating member 85 is located behind the front end of the front tube portion 84A. The front ends of the pin terminals 83 are located between the front end of the front tube portion 84A and that of the insulating member 85 in the front-rear direction. The front end of the insulating member 85 corresponds to a “back wall of a tube portion” of the present disclosure.

The tab terminal 82 is provided with a flat plate-like tab portion and a barrel portion disposed behind the tab portion. The barrel portion includes barrel pieces and the barrel pieces are crimped to a core wire and a wire coating constituting a coated wire, whereby the tab terminal 82 and the coated wire are electrically and mechanically connected.

### (Male Housing 60)

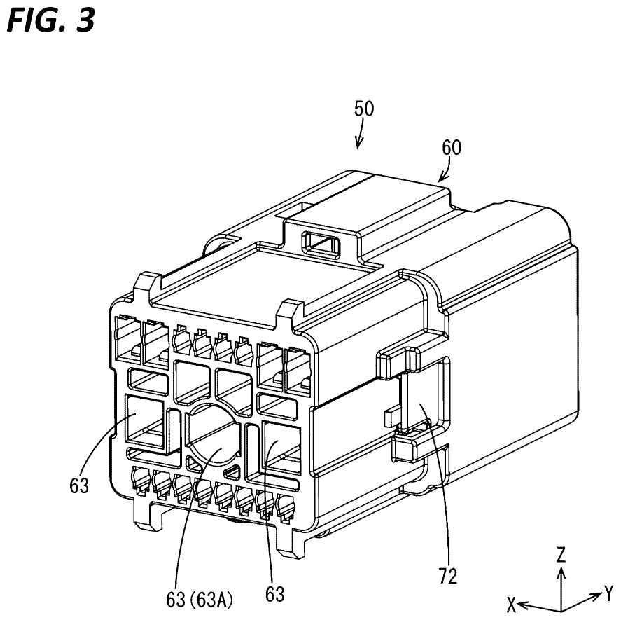

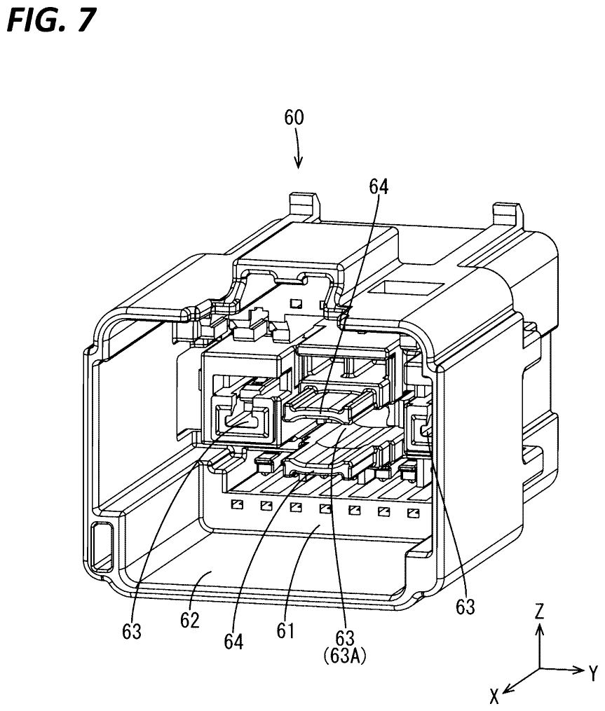

As shown in FIGS. 3 and 7, the male housing 60 is provided with a male housing body 61 substantially in the form of a rectangular block and a male receptacle 62 extending forward from the front end outer peripheral edge of the male housing body 61. The male receptacle 62 is in the form of a rectangular tube and open forward. The front surface of the male housing body 61 is exposed forward via an internal space of the male receptacle 62.

A plurality of male cavities 63 for respectively accommodating the plurality of types of male terminals 80 are formed inside the male housing body 61. Out of the plurality of male cavities 63, the male cavity 63A for accommodating the elliptical terminal 81 is located in a central part of the male housing 60 in a front view. The male terminal 80 is inserted into the male cavity 63A from behind.

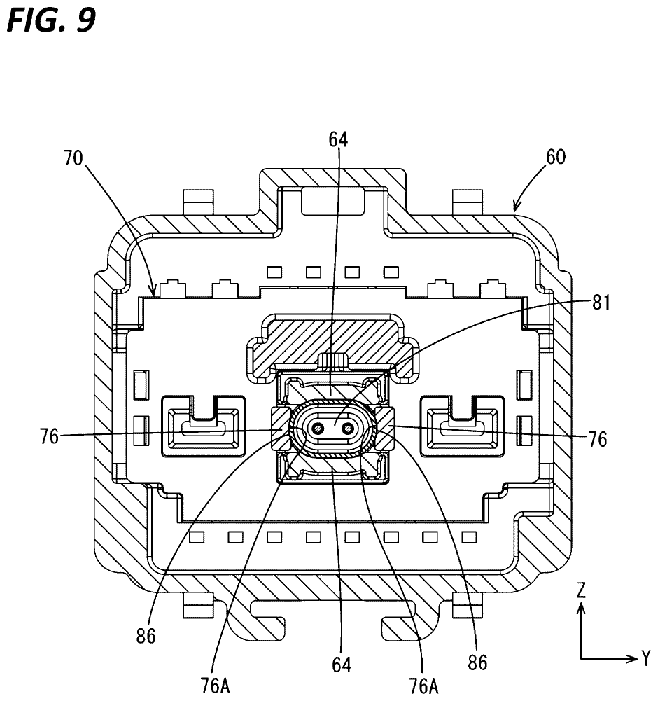

The male cavity 63A is formed between a pair of upper and lower male terminal accommodation walls 64. As shown in FIG. 9, the male terminal accommodation walls 64 are formed along the upper and lower surfaces of the shield member 84 of the elliptical terminal 81 and the arcuate surfaces 86 connected to both sides of the upper and lower surfaces. Therefore, the elliptical terminal 81 is suppressed from moving in the vertical direction and the lateral direction by the pair of male terminal accommodation walls 64.

As shown in FIG. 11, a pair of left and right locking lances 65 disposed side by side in the lateral direction are provided inside the male cavity 63A. The locking lance 65 is cantilevered forward from an inner wall constituting the male cavity 63A. The locking lance 65 is formed to be deflectable in the lateral direction. Locking portions 65A are respectively formed on facing surfaces of the pair of locking lances 65 facing each other. The locking portions 65 of the pair of locking lances 65 are respectively locked to the pair of locked portions 87 of the elliptical terminal 81, whereby the elliptical terminal 81 is retained and held not to come out rearward.

A pair of holding projections 66 are respectively formed on both left and right sides of the outer peripheral surface of the male housing body 61. The male retainer 70 is movable between a temporary locking position (position of the male retainer 70 shown in FIG. 10) and a complete locking position (position of the male retainer 70 shown in FIG. 11) with respect to the male housing 60. The male retainer 70 is configured to be holdable at each of the temporary locking position and the complete locking position by being locked by the pair of holding projections 66.

### (Male Retainer 70)

As shown in FIG. 4, the male retainer 70 is provided with a male retainer body 71 constituting the front surface of the male housing 60, a pair of mounting portions 72 disposed on both left and right sides of the male retainer body 71 and a pair of deflection suppressing portions 75 projecting rearward from the rear surface of the male retainer body 71. The male retainer body 71 includes a pair of terminal insertion holes 73, through which the male terminals 80 are inserted. The male retainer 70 is mounted on the male housing 60 from front. A connection surface of the male housing 60 is constituted by the male retainer body 71 of the male retainer 70.

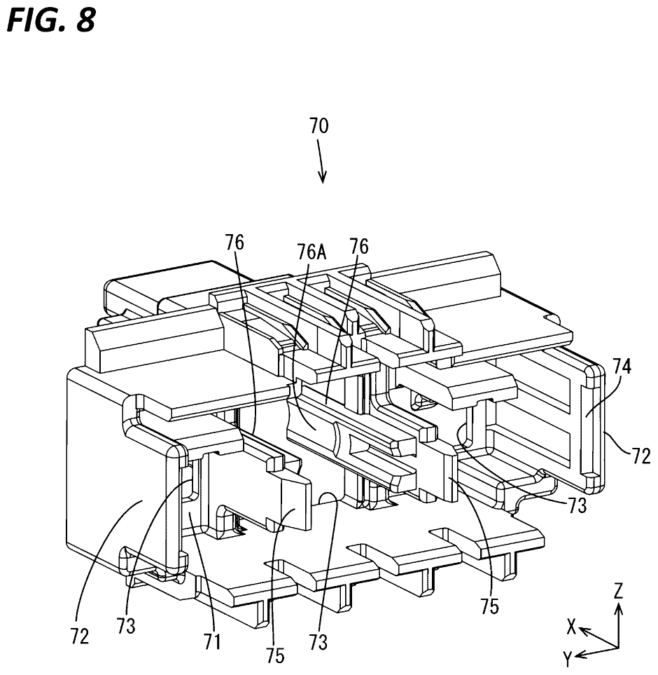

As shown in FIG. 8, mounting protrusions 74 extending in the vertical direction are respectively formed on facing surfaces of the pair of mounting portions 72 facing each other. At the temporary locking position, the holding projections 66 shown in FIG. 10 are locked to the mounting protrusions 74, whereby a rearward movement of the male retainer 70 is suppressed. At the complete locking position, the holding projections 66 shown in FIG. 11 are locked to the mounting protrusions 74, whereby a forward movement of the male retainer 70 is suppressed.

As shown in FIG. 8, a pair of deflection suppressing portions 75 are formed on the rear surface of the male retainer body 71. The deflection suppressing portion 75 projects rearward from the hole edge of the terminal insertion hole 73. The pair of deflection suppressing portions 75 are disposed to face each other in the lateral direction. A pair of supporting walls 76 are formed to project in directions toward each other on inner sides of the pair of deflection suppressing portions 75. The supporting wall 76 is integrally formed to the deflection suppressing portion 75. Thus, the deflection suppressing portion 75 is reinforced by the supporting wall 76. The rear end of the supporting wall 76 is located in front of the rear end of the deflection suppressing portion 75.

The supporting wall 76 has a curved surface 76A formed along the arcuate surface 86 of the elliptical terminal 81. The curved surface 76A substantially entirely contacts the arcuate surface 86. As shown in FIGS. 9 and 11, a pair of the curved surfaces 76A contact the pair of arcuate surfaces 86 at the complete locking position. The curved surface 76A contacts the arcuate surface 86 in the lateral direction and in the vertical direction. Thus, the elliptical terminal 81 neither rattles in the lateral direction nor drops down at the complete locking position. Further, since the pair of curved surfaces 76A are partially in contact with the pair of arcuate surfaces 86 also at the temporary locking position as shown in FIG. 10, the elliptical terminal 81 neither rattles in the lateral direction nor drops down at the temporary locking position. The elliptical terminal 81 is held in the male housing body 61 in a state where the arcuate surfaces 86 of the front tube portion 84A are supported from both sides in the lateral direction by the pair of supporting walls 76 at both the temporary locking position and the complete locking position. That is, the curved surfaces 76A support the front tube portion 84A from both sides in the lateral direction while contacting the arcuate surfaces 86.

The pair of supporting walls 76 support a part in front of the front end of the insulating member 85, out of the outer peripheral surface of the front tube portion 84A, at both the temporary locking position and the complete locking position. At the temporary locking position, the front ends of the pair of supporting walls 76 are located in front of the front end of the front tube portion 84A.

Since the pair of deflection suppressing portions 75 are retracted from deflection spaces for the pair of locking lances 65 at the temporary locking position, the deflection of the pair of locking lances 65 is allowed. On the other hand, since the pair of deflection suppressing portions 75 are located in the deflection spaces for the pair of locking lances 65 at the complete locking position, the deflection of the pair of locking lances 65 is suppressed. Thus, at the complete locking position, the elliptical terminal 81 is doubly locked by the pair of locking lances 65 and the pair of deflection suppressing portions 75.

FIG. 12 shows a state where the male housing 60 and the female housing 20 are properly connected. In this state, the elliptical terminal 81 of the male connector 50 is electrically connected to the female terminal 40 of the male connector 10. As described above, the female connector 10 is configured similarly to the male connector 50. That is, the female connector 10 is provided with the female housing 20 connectable to the male housing 60 and the female retainer 30 to be mounted on the female housing 20. The female retainer 30 is provided with a female retainer body 31, a pair of supporting walls 32 and a pair of deflection suppressing portions 33. The pair of supporting walls 32 support the outer peripheral surface of the female terminal 40 from the both sides in the lateral direction and support the outer peripheral surface of the front tube portion 84A of the elliptical terminal 81 from the both sides in the lateral direction. The female housing 20 corresponds to a “mating housing” of the present disclosure, the female retainer 30 corresponds to a “mating retainer” of the present disclosure and the supporting wall 32 corresponds to a “mating supporting wall” of the present disclosure.

The female retainer body 31 of the female retainer 30 is formed with a terminal insertion opening 34, through which the male terminals 80 are inserted from front. The pair of supporting walls 76 are inserted together with the male terminals 80 into the terminal insertion opening 34. The deflection suppressing portions 33 are located in deflection spaces for locking lances 21 provided inside the female housing 20.

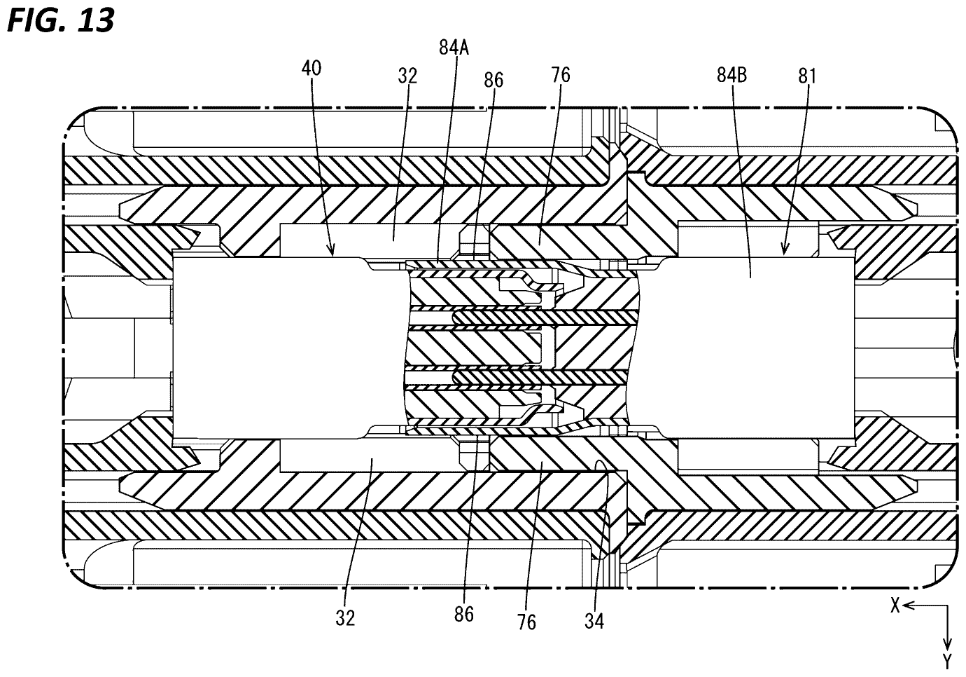

As shown in FIG. 13, the front tube portion 84A of the elliptical terminal 81 is supported from the both sides in the lateral direction by both the pair of supporting walls 76 of the male retainer 70 and the pair of supporting walls 32 of the female retainer 30. As shown in FIG. 11, a part of the front tube portion 84A projects further forward than the front walls of the pair of supporting walls 76, but this projecting part is supported by the pair of supporting walls 32 of the female retainer 30. Particularly, since the vicinities of contact point portions where the pin terminals 83 of the elliptical terminal 81 are connected to the female terminal 40 are supported by the supporting walls 32, 76 of the both male and female retainers 30, 70, the wear of the contact point portions are easily suppressed.

### Functions and Effects of Embodiment

(1) The male connector 50 of the embodiment is provided with the plurality of types of male terminals 80 disposed side by side in the lateral direction, the male housing 60 including the plurality of male cavities 63 for respectively accommodating the plurality of types of male terminals 80, the male terminals 80 being inserted into the male cavities 63 from behind in the front-rear direction intersecting the lateral direction, and the male retainer 70 to be mounted on the male housing 60 from front in the front-rear direction. The inner wall of the male cavity 63 is formed with the pair of locking lances 65 disposed side by side in the lateral direction. The plurality of types of male terminals 80 include at least one elliptical terminal 81 having an elliptical shape in a front view. The elliptical terminal 81 includes the front tube portion 84A open forward and long in the lateral direction and the pair of locked portions 87 for holding the elliptical terminal 81 by being locked by the pair of locking lances 65. The pair of locking lances 65 are deflectable in the lateral direction. The male retainer 70 includes the pair of deflection suppressing portions 75 for respectively suppressing the deflection of the pair of locking lances 65 by respectively entering the deflection spaces for the pair of locking lances 65 and the pair of supporting walls 76 for supporting the outer peripheral surface of the front tube portion 84A from the both sides in the lateral direction.

According to this configuration, the pair of supporting walls 76 support the front tube portion 84A of the elliptical terminal 81 from the both sides in the lateral direction, thereby preventing a movement of the elliptical terminal 81 in the lateral direction. Since the male retainer 70 is provided with the pair of supporting walls 76, the rattling of the elliptical terminal 81 in the male cavity 63A can be suppressed by providing the pair of supporting walls 76 in accordance with a dimension in the lateral direction of the elliptical terminal 81 regardless of tolerance for assembling the male retainer 70 with the male housing 60.

(2) The elliptical terminal 81 includes the pin terminals 83 accommodated in the front tube portion 84A and long in the front-rear direction, the front end of the pin terminal 83 is located between the front end of the front tube portion 84A and the front end of the insulating member 85 in the front-rear direction, and the pair of supporting walls 76 support the part in front of the front end of the insulating member 85, out of the outer peripheral surface of the front tube portion 84A.

By supporting the part in front of the front end of the insulating member 85, out of the outer peripheral surface of the front tube portion 84A, by the pair of supporting walls 76, the rattling of the elliptical terminal 81 in the male cavity 63A is easily suppressed.

(3) The front tube portion 84A has the pair of arcuate surfaces 86 located on the both end parts in the lateral direction, the supporting walls 76 have the curved surfaces 76A formed along the arcuate surfaces 86, and the curved surfaces 76A support the front tube portion 84A from the both sides in the lateral direction while contacting the arcuate surfaces 86.

By doing so, the front tube portion 84A of the elliptical terminal 81 can be supported from the both sides in the lateral direction with the curved surfaces 76A of the respective supporting walls 76 held in contact with the arcuate surfaces 86 of the front tube portion 84A.

(4) The male retainer 70 is movable between the temporary locking position for allowing the deflection of the pair of locking lances 65 and the complete locking position for suppressing the deflection of the pair of locking lances 65, and the front ends of the pair of supporting walls 76 are located in front of the front end of the front tube portion 84A at the temporary locking position.

Since the front ends of the pair of supporting walls 76 are located in front of the front end of the front tube portion 84A, the front tube portion 84A is easily protected from the both sides in the lateral direction at the temporary locking position.

(5) The connector device 100 of the present disclosure is provided with the male connector 50, the female housing 20 connectable to the male housing 60 and the female retainer 30 to be mounted on the female housing 20, and the female retainer 30 includes the pair of supporting walls 32 for supporting the outer peripheral surface of the front tube portion 84A from the both sides in the lateral direction together with the pair of supporting walls 76 when the male housing 60 and the female housing 20 are connected.

According to this configuration, both the pair of supporting walls 76 and the pair of supporting walls 32 support the front tube portion 84A of the elliptical terminal 81 from the both sides in the lateral direction, whereby the elliptical terminal 81 is prevented from moving in the lateral direction.

### Other Embodiments

The above embodiment can be modified and carried out as follows. The above embodiment and the following modifications can be carried out in combination without technically contradicting each other.
Although the pair of supporting walls 76 support the elliptical terminal 81 at both the temporary locking position and the complete locking position in the above embodiment, a pair of supporting walls may support an elliptical terminal only at a temporary locking position.
Although the pair of locking lances 65 are disposed side by side in the lateral direction in the above embodiment, a pair of locking lances may be disposed side by side in the vertical direction.
Although the male retainer 70 is not formed with jig insertion holes in the above embodiment, a male retainer may be formed with jig insertion holes.
Although the pair of supporting walls 76 support the part of the front tube portion 84A in front of the front end of the insulating member 85 in the above embodiment, a part behind the front end of an insulating member may be supported.
Although the supporting wall 76 has the arcuate curved surface 76A in the above embodiment, a supporting wall may have a gate-shaped supporting surface.
Although the front ends of the pair of supporting walls 76 are located in front of the front end of the front tube portion 84A at the temporary locking position in the above embodiment, the front ends of a pair of supporting walls may be located at the same position as or behind the front end of a front tube portion.
Although the front tube portion 84A is supported by both the pair of supporting walls 32 of the female retainer 30 and the pair of supporting walls 76 of the male retainer 70 at the complete locking position in the above embodiment, a front tube portion may be supported only by a pair of supporting walls of a male retainer.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a plurality of types of terminals disposed side by side in a first direction;
a housing including a plurality of cavities for respectively accommodating the plurality of types of terminals, the terminals being inserted into the cavities from behind in a second direction intersecting the first direction; and
a retainer to be mounted on the housing from front in the second direction,
an inner wall of the cavity being formed with a pair of locking lances disposed side by side in the first direction,
the plurality of types of terminals including at least one elliptical terminal having an elliptical shape in a front view,
the elliptical terminal including a tube portion open forward and long in the first direction and a pair of locked portions for holding the elliptical terminal by being respectively locked by the pair of locking lances,
the pair of locking lances being deflectable in the first direction, and
the retainer including a pair of deflection suppressing portions for respectively suppressing deflection of the pair of locking lances by respectively entering deflection spaces for the pair of locking lances and a pair of supporting walls for supporting an outer peripheral surface of the tube portion from both sides in the first direction.

2. The connector of claim 1, wherein:
the elliptical terminal includes a terminal portion accommodated in the tube portion and long in the second direction,
a front end of the terminal portion is located between a front end of the tube portion and a back wall of the tube portion in the second direction, and
the pair of supporting walls support a part in front of the back wall, out of the outer peripheral surface of the tube portion.

3. The connector of claim 1, wherein:
the tube portion has a pair of arcuate surfaces located on both end parts in the first direction,
the supporting walls have curved surfaces formed along the arcuate surfaces, and
the curved surfaces support the tube portion from the both sides in the first direction while contacting the arcuate surfaces.

4. The connector of claim 1, wherein:
the retainer is movable between a temporary locking position for allowing the deflection of the pair of locking lances and a complete locking position for suppressing the deflection of the pair of locking lances, and
front ends of the pair of supporting walls are located in front of the front end of the tube portion at the temporary locking position.

5. A connector device, comprising:
the connector of claim 1;
a mating housing connectable to the housing; and
a mating retainer to be mounted on the mating housing,
the mating retainer including a pair of mating supporting walls for supporting the outer peripheral surface of the tube portion from the both sides in the first direction together with the pair of supporting walls when the housing and the mating housing are connected.
